(19) United States
(12) Patent Application Publication
(10) Pub. No.: US 2026/0328167 A1
(43) Pub. Date: Oct. 22, 2026

(54) THERMAL EFFICIENCY AND POLLUTANTS CONTROL OF AMMONIA FUELED MARINE ENGINE BY INTRODUCING ON-BOARD HYDROGEN INTO THE COMBUSTION CHAMBER

(71) Applicant: SAUDI ARABIAN OIL COMPANY, Dhahran (SA)

(72) Inventors: Vallinayagam Raman, Dhahran (SA); Junseok Chang, Dhahran (SA)

(73) Assignee: SAUDI ARABIAN OIL COMPANY, Dhahran (SA)

(21) Appl. No.: 19/180,449

(22) Filed: Apr. 16, 2025

(51) Int. Cl. F02M 21/02; F02M 25/10

(52) U.S. Cl. CPC F02M 21/0206; F02M 21/0227; F02M 25/10

(57) ABSTRACT

A system includes dual fuel injector disposed centrally on a cylinder has a first set of one or more nozzles for injecting an ammonia stream and a second set of one or more nozzles for injecting a hydrogen stream. The spark plug is disposed adjacent to the dual fuel injector and in the fluid communication with the main combustion chamber. The ammonia and hydrogen tanks are fluidly connected to a first and a second set of one or more orifices of the dual fuel injector. A first ammonia stream is reformed in an ammonia reformer, producing a reformer effluent stream including a hydrogen stream. The reformer effluent stream and a second ammonia stream are supplied to a dual fuel injector. The hydrogen stream and the second ammonia stream are combusted in a main combustion chamber of the ammonia-fueled engine.

### BACKGROUND

The Marine Environmental Protection Committee (MEPC) has recently revised the Green House Gas (GHG) strategy with the aim of zero GHG emissions by 2050. Transition towards low carbon or zero carbon fuels has been viewed as a potential path. For example, ammonia is a potential candidate as zero carbon fuel, and the use of ammonia in marine engines significantly reduces GHG emissions. Similarly, hydrogen may be directly injected into an engine cylinder of ammonia fueled marine engines in order to improve the engine performance and reduce emissions during combustion. However, due to poor flame speed and ignition properties, ammonia slip and associated toxicity issues arise using ammonia in the marine engines. The use of hydrogen as a pilot fuel instead of using diesel improves ammonia combustion and reduces ammonia slip by increasing the flame propagation thereby minimizing unburnt or slipped ammonia in the engine exhaust. As a result, marine engine manufactures strive towards the development of ammonia fueled marine engines.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A system includes a dual fuel injector, a spark plug, an ammonia tank, and a hydrogen tank. The dual fuel injector is disposed centrally on a cylinder head and in fluid communication with a main combustion chamber of a marine engine. The dual fuel injector has a first set of one or more nozzles for injecting an ammonia stream and a second set of one or more nozzles for injecting a hydrogen stream. The spark plug is disposed adjacent to the dual fuel injector and in the fluid communication with the main combustion chamber. The ammonia tank is fluidly connected to a first set of one or more orifices of the dual fuel injector. The hydrogen tank is connected to a second set of one or more orifices of the dual fuel injector.

A method includes reforming a first ammonia stream in an ammonia reformer, producing a reformer effluent stream including a hydrogen stream. The method further includes supplying the reformer effluent stream to a dual fuel injector of an ammonia-fueled engine. A second ammonia stream is fed to the dual fuel injector. The hydrogen stream and the second ammonia stream are combusted in a main combustion chamber of the ammonia-fueled engine. The method further includes combusting a hydrogen feed stream and an ammonia stream in the marine internal combustion engine, producing an exhaust gas ammonia stream. The exhaust gas ammonia stream is reformed in an exhaust gas reformer, generating the hydrogen feed stream and an exhaust gas stream. The method also includes supplying the hydrogen feed stream to a first set of nozzles on a dual fuel injector of the marine internal combustion engine. The ammonia stream is fed to a second set of nozzles on the dual fuel injector of the marine internal combustion engine.

In yet another aspect, embodiments disclosed herein relate to a method. The method includes injecting hydrogen directly into an engine cylinder through a dual fuel injector, injecting both ammonia and hydrogen through the same dual fuel injector with a spark plug to ignite the fuel, supplying fresh ammonia feed from an ammonia tank, and supplying fresh hydrogen feed from a hydrogen tank. For the onboard direct reforming system, the method includes reforming a first ammonia stream in an ammonia reformer, separating a generated hydrogen stream from other reformed products, supplying a pure hydrogen stream into the dual fuel injector with a membrane reformer, ensuring pressure drop across the membrane reformer for effective separation of the reformed product from the rest of the mixture in the membrane reformer, and pressurizing hydrogen to desired pressure, and supplying hydrogen into the dual fuel injector using an external pump at the exit of the membrane reformer. For the exhaust gas reforming system, the method includes reforming an exhaust gas ammonia stream in an exhaust gas reformer, generating hydrogen using a membrane-based reactor in an engine exhaust, and converting unburnt ammonia in an exhaust into hydrogen with the exhaust gas reformer.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

FIG. 1 depicts an ammonia marine engine operation using a dual fuel injector in accordance with one or more embodiments of the present disclosure.

FIGS. 2A and 2B depict a dual fuel injector in accordance with one or more embodiments of the present disclosure.

FIGS. 3A and 3B depict ammonia and hydrogen spray patterns in accordance with one or more embodiments of the present disclosure.

FIG. 4 depicts a system for onboard direct reforming of ammonia into hydrogen in accordance with one or more embodiments of the present disclosure.

FIG. 5 depicts a system for exhaust gas reforming of ammonia into hydrogen in accordance with one or more embodiments of the present disclosure.

FIG. 6 is a flow diagram of an onboard reforming process in accordance with one or more embodiments of the present disclosure.

FIG. 7 is a flow diagram of an exhaust gas reforming process in accordance with one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “palette” may include any number of “palettes” without limitation. Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In terms of engine configuration, multiple engine types may be used in embodiments disclosed herein. For example, a compression ignition (CI) engine may modified to add spark plug positioned adjacent to a centrally mounted dual fuel injector, operating under spark ignited combustion mode. Similarly, a spark ignition (SI) engine with the centrally mounted dual fuel injector and the spark plug positioned adjacent to the dual fuel injector operates under spark ignited combustion mode. With the addition of the spark plug to the CI engine, the primary difference between the SI engine and a spark ignited CI engine is the shape of the combustion chamber. Accordingly, while embodiments disclosed herein may be described with respect to CI or SI engines, it is to be understood that either type may be used in any embodiment.

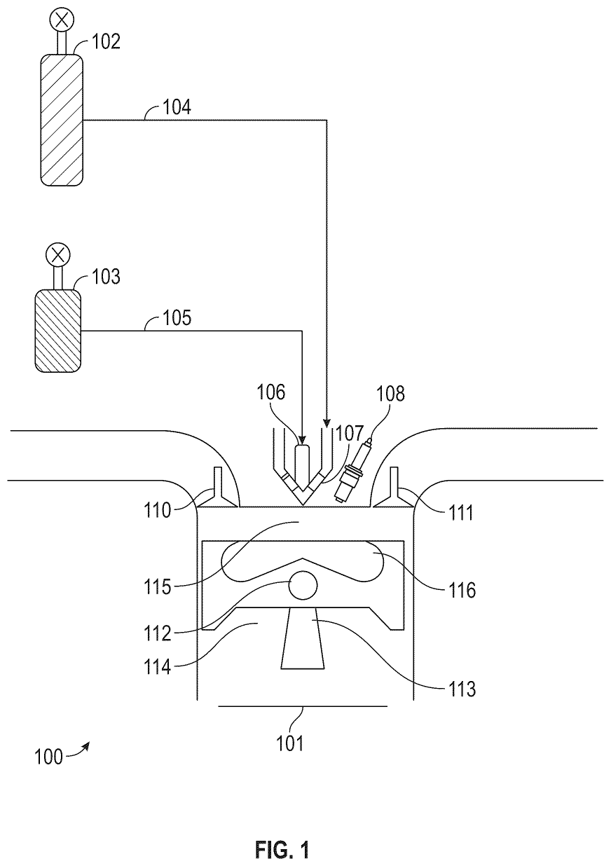

In one aspect, embodiments disclosed herein relate to an ammonia marine engine operation using a dual fuel injector. FIG. 1 illustrates a marine engine system 100 using a dual fuel injector 106. The marine engine system 100 includes a marine engine 101, a dual fuel injector 106, a nozzle 107, a spark plug 108, an ammonia tank 102 supplying an ammonia stream 104 to the dual fuel injector 106, and a hydrogen tank 103 supplying a hydrogen stream 105 to the dual fuel injector 106. The marine engine 101 includes an intake valve 110, a cylinder head 115, a cylinder 114, a piston rod 113, a piston 112, a main combustion chamber 116, and an exhaust valve 111. Suitable types of the marine engines 101 may include outboard, inboard, sterndrive, and jet drive engines. The particular structure and type of the marine engine is not intended to limit the functionality of the marine engine system 100 as described herein.

The dual fuel injector 106 is positioned centrally on the cylinder head 115 and is in fluid communication with the main combustion chamber 116 of the marine engine 101. Additionally, the dual fuel injector 106 has a first set of nozzles for injecting the ammonia stream 104 and a second set of nozzles for injecting a hydrogen stream 105. In the context of this application, the term “dual fuel injector” refers to the marine engine system 100 to inject both ammonia stream 104 and hydrogen stream 105 into the cylinder 114 with separate fuel galleries and metering controls for each fuel. Conventionally, marine engines use diesel as a pilot fuel for combustion of ammonia. By replacing diesel with hydrogen as pilot fuel, 100% use of carbon neutral fuel may be achieved.

In terms of fuel injection systems, a “port injection” system injects fuel into an intake manifold upstream of a main combustion chamber, and a “direct injection” system sprays or injects fuel directly into the main combustion chamber. While embodiments disclosed herein generally relate to direct injection systems, port injection systems are also contemplated. The dual fuel injector 106 sprays fuels directly into the main combustion chamber 116 of the marine engine 101. Both ammonia and hydrogen fuels are injected directly into the main combustion chamber 116 via the dual fuel injector 106 at different injection rates. By controlling the mixture, the dual fuel injector 106 leads to better combustion and fuel economy. To inject the fuels directly into the main combustion chamber 116, the dual fuel injector 106 uses high-pressure pumps to operate. The dual fuel injector 106 injects both fuels simultaneously at high pressure, mixing the fuels within the main combustion chamber 116. In some embodiments, hydrogen is injected through the center of the nozzle, and ammonia is injected from the side of the injector nozzle. In other embodiments, ammonia is injected through the center of the nozzle, and hydrogen is injected from the side of the nozzle.

In another aspect, embodiments disclosed herein relate to a process for spark-ignition, instead of auto-ignition. The spark ignition process relates to the combustion process where a spark is initiated by a spark plug 108, whereas the auto ignition process ignites a fuel mixture without an external ignition source by using high pressure within the combustion chamber. To facilitate the process of spark-ignition, a spark plug 108 is disposed within the cylinder head 115 of the marine engine 101. The spark plug 108 is positioned proximate to the dual fuel injector 106 and is in fluid communication with the main combustion chamber 116. To support flame propagation from the spark plug 108 and initiate the combustion of ammonia-hydrogen mixture, a flat cylinder head 115 may be used. The “flat” cylinder head refers to a “flathead” design, where a relatively flat, simple head with valves is located within the cylinder block of the engine.

In terms of an engine stroke, embodiments disclosed herein take place during a compression stroke. The compression stroke is a phase in an internal combustion engine where the piston 112 moves up the cylinder 114 to compress the hydrogen-ammonia mixture. The intake valve 110 and the exhaust valve 111 are closed during the compression stroke. In the compression stroke, the hydrogen-ammonia mixture is compressed before ignition.

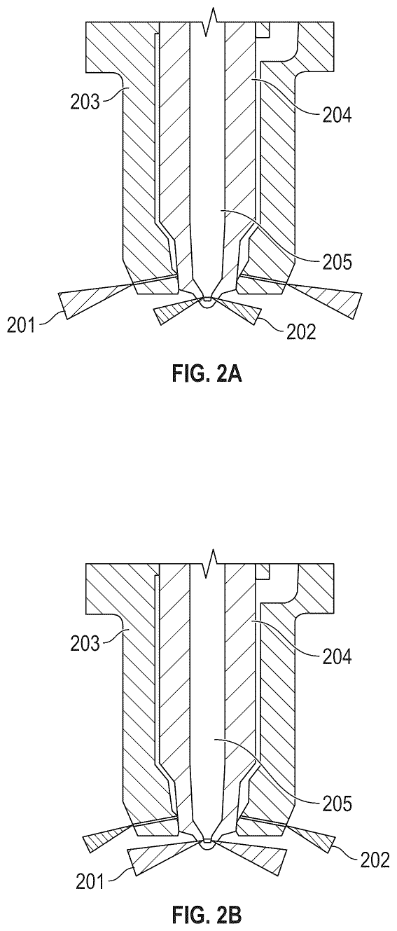

In some embodiments, hydrogen is injected through the center of the dual fuel injector nozzle, whereas ammonia is injected from the side of the dual fuel injector nozzle. The injection of hydrogen from the center of the nozzle forms a stratified hydrogen mixture around the periphery of the spark plug 108 as illustrated in FIG. 2A. In other embodiments, ammonia is injected through the center of the dual fuel injector nozzle. As illustrated in FIG. 2B, hydrogen is injected from the side of the dual fuel injector nozzle.

Due to ignition properties of ammonia, higher compression ratio and stoichiometric air fuel distribution are required to initiate combustion with the addition of hydrogen. Similarly, stoichiometric air/fuel to slightly lean mixture is required through locally rich hydrogen pockets around the spark plug 108 to initiate ignition. The hydrogen pockets can be understood as rich hydrogen concentration zones around the spark plug.

In terms of engine configurations, embodiments disclosed herein relate to a compression ignition (CI) engine that has a compression ratio of 16 to 20 with mixture distribution from stoichiometric to slightly lean operation. In contrast, a spark ignition (SI) engine has a compression ratio (up to 11 or 12) with stoichiometric to slightly lean operation. Burning ammonia in stoichiometric conditions increases flame propagation and improves ammonia ignition and combustion. Since the ignition properties of ammonia are not favorable, higher compression ratio and stoichiometric air fuel distribution are maintained with the support of hydrogen addition to improve combustion.

In one aspect, embodiments disclosed herein relate to a dual fuel injector with ammonia and hydrogen sprays. FIGS. 2A and 2B illustrate a dual fuel injector of ammonia and hydrogen sprays in accordance with one or more embodiments disclosed herein. The dual fuel injector 106 includes an injector body 203, an ammonia needle 204, and a hydrogen needle 205. The ammonia nozzles are deployed around the hydrogen nozzle in the periphery of the injector body 203. The ammonia needle 204 and the hydrogen needle 205 are used to open the nozzle for injecting both ammonia and hydrogen separately.

Specifically, FIG. 2A illustrates a nozzle where hydrogen is injected through the center of the nozzle, and ammonia is injected from the side of the nozzle. This shows ammonia can be injected either from the upper side or the lower side of the nozzle, vice versa. FIG. 2B illustrates the nozzle where ammonia is injected through the center of the nozzle, and hydrogen is injected from the size of the nozzle, vice versa. There are nozzles for ammonia and nozzles for hydrogen in the same dual fuel injector 106. Both fuels are injected into the cylinder 114 of the marine engine 101 through one or more orifices.

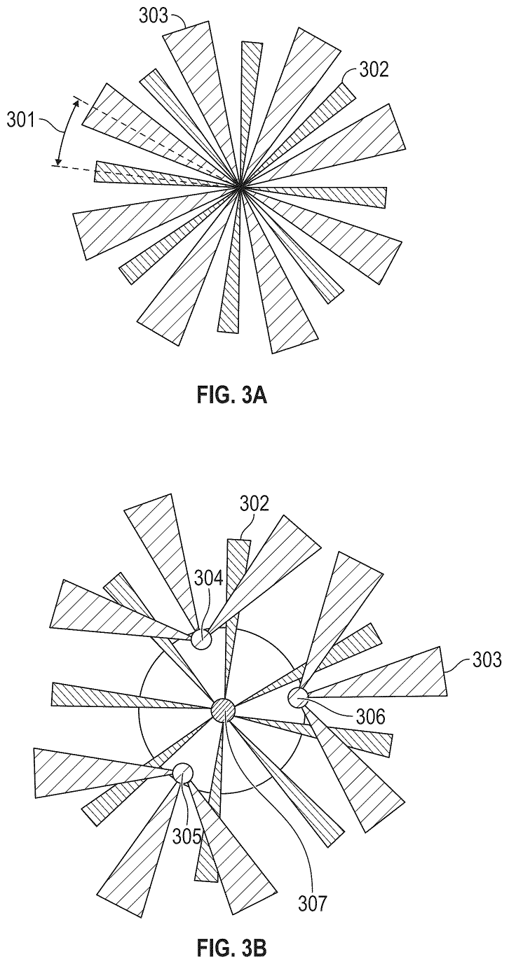

In one aspect, embodiments disclosed herein relate to hydrogen and ammonia sprays with respect to angle between spray jets. Turning to FIG. 3A, FIG. 3A illustrates an ammonia and hydrogen spray pattern. Ammonia spray 303 provides a larger surface area of spray coverage than hydrogen spray 302 since injection quantity of ammonia is higher. As illustrated in FIG. 3A, when the hydrogen spray 302 and the ammonia spray 303 form the sloping sides of a cone, which is referred to a ‘cone angle.’ In other embodiments, the cone angle refers to the angle which is formed between the slant height and the axis of the cone, with the apex as the vertex. The spray cone angle 301 between the ammonia spray 303 and the hydrogen spray 302 is in the same plane, and the spray cone angle 301 can be different or the same. The spray cone angle 301 can vary from 0° to 20°. In other embodiments, the spray angles may vary based on the combustion chamber and engine configuration.

Referring now to FIG. 3B, FIG. 3B illustrates a top view of the nozzle for ammonia and hydrogen holes. There is one central single nozzle for hydrogen 307, a first nozzle for ammonia 304, a second nozzle for ammonia 305, and a third nozzle for ammonia 306. Number of holes for injecting ammonia includes between 8 to 10 holes with a larger nozzle diameter between 300 microns and 500 microns. The number of holes for injecting hydrogen includes between 10 to 12 nozzle holes with a smaller nozzle diameter up to 150 microns. As illustrated in FIG. 3B, the hydrogen hole is surrounded by two or more ammonia homes in the same dual fuel injector 106.

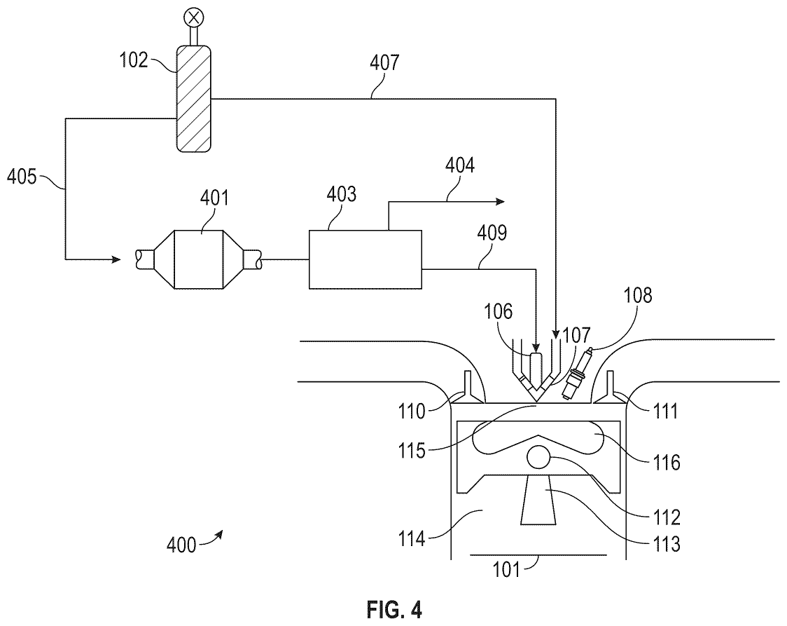

In one aspect, embodiments disclosed herein relate to a process for onboard ammonia reforming. FIG. 4 illustrates an onboard direct reforming system 400, which reforms ammonia into hydrogen to supply hydrogen into the dual fuel injector 106. An ammonia reformer 401 receives a first ammonia stream 405 from an ammonia tank 102, producing a reformer effluent stream including a hydrogen stream 409. The reformer effluent stream is then supplied to the dual fuel injector 106. A second ammonia stream 407 is also fed to the dual fuel injector 106. Then, the hydrogen stream 409 and the second ammonia stream 407 are combusted in a main combustion chamber 116 of a marine engine 101. The reformer effluent stream is separated into a generated hydrogen stream and a pure hydrogen stream, which is supplied into the dual fuel injector 106. As discussed in relation to FIG. 1, the spark plug 108 is positioned adjacent to the dual fuel injector 106 and is in the fluid communication with the main combustion chamber 116. In addition to the spark plug 108, the marine engine 101 includes an intake valve 110, a cylinder head 115, a cylinder 114, a piston rod 113, a piston 112, a main combustion chamber 116, and an exhaust valve 111.

The onboard direct reforming process begins with reforming the first ammonia stream 405 in the ammonia reformer 401. Specifically, the ammonia reformer 401 is used to generate hydrogen from an ammonia stream. The reformer effluent is then fed to a selective membrane 403 where the reformer effluent is separated into a pure hydrogen stream 409 and a retentate stream 404 containing byproduct gases. The pure hydrogen stream 409 is then fed into the dual fuel injector 106. The selective membrane 403 is utilized to separate hydrogen from other byproduct gases using a pressure drop across the selective membrane. For specific injection pressure requirements for hydrogen, an external pump (not shown) may be present at an exit of the selective membrane 403 and is used to both pressurize hydrogen from 100 bar to 300 bar and supply hydrogen into the dual fuel injector 106.

In the direct reforming process, hydrogen is generated onboard and used as pilot fuel to improve ammonia combustion and minimize ammonia slip, without the need to store hydrogen onboard. The energy required to reform is availed from the waste energy recovered from an engine exhaust using a heat exchanger (not shown). Otherwise, an external heater (not shown) may be used to reform ammonia onboard. Overall, generating hydrogen onboard and using hydrogen as pilot fuel improves ammonia combustion and minimizes ammonia slip. For direct reforming in the absence of oxygen, thermal reforming is preferred.

2 NH₃=3H₂+N₂

ΔH=46 kj=mol

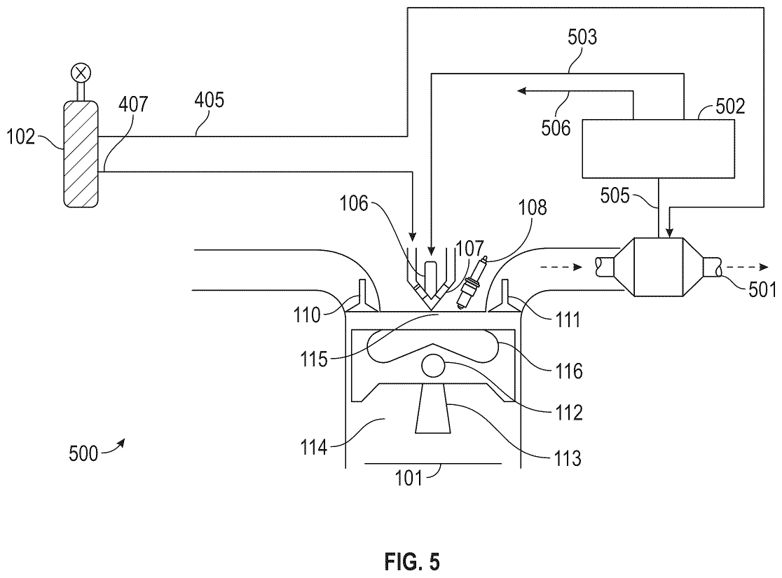

Referring now to FIG. 5, FIG. 5 illustrates an exhaust gas reforming of ammonia into hydrogen using an exhaust gas ammonia reformer 501. The exhaust gas ammonia reformer 501 is fluidly connected to an ammonia tank 102 located by an exit of an exhaust valve 111, receiving a first ammonia stream 405 from the ammonia tank 102. Then, the exhaust gas ammonia reformer 501 reforms unburnt ammonia, generating a raw hydrogen stream 505. The raw hydrogen stream 505 is fed to a selective membrane 502 where the raw hydrogen stream 505 is separated into a pure hydrogen stream 503 and a retentate stream 506 containing byproduct gases. The pure hydrogen stream 503 is then fed to the dual fuel injector 106. A second ammonia stream 407 is also supplied to the dual fuel injector 106 from the ammonia tank 102. As discussed in relation to FIG. 1, the spark plug 108 is also positioned adjacent to the dual fuel injector 106 and is in fluid communication with the main combustion chamber 116. In addition to the spark plug 108, the marine engine 101 includes an intake valve 110, a cylinder head 115, a cylinder 114, a piston rod 113, a piston 112, a main combustion chamber 116, and an exhaust valve 111.

The exhaust gas reforming process is another way of reforming ammonia into hydrogen onboard using the exhaust gas ammonia reformer 501. The first ammonia stream 405 is supplied to the exhaust gas ammonia reformer 501. Then, the exhaust gas ammonia reformer 501 reforms unburnt ammonia and/or fresh ammonia and produces the hydrogen stream 505. The hydrogen stream 505 is supplied to the hydrogen selective membrane 502, producing a pure hydrogen stream 503 and a retentate stream 506. Byproducts include N₂and H₂₀. The hydrogen stream 503 is also supplied to the dual fuel injector 106. The second ammonia stream 407 is also fed to the dual fuel injector 106. Then, an exhaust gas ammonia stream and the second ammonia stream 407 are combusted in the main chamber 116 of the marine engine 101.

The exhaust gas ammonia reformer 501 utilizes the engine exhaust heat to reform ammonia into hydrogen. If there needs to be any additional heat, an external heater (not shown) may be utilized to provide heat to set a catalytic surface to a desired temperature. A vacuum pump (not shown) may be used to suck air from the engine in order to remove any air and gas built up in the engine. By utilizing the vacuum pump located at the outlet of the exhaust gas reformer 501, conversion efficiency is improved by creating differential pressure across membranes. In another aspect, the “pressure differential” refers to the difference in pressure between two points in a system.

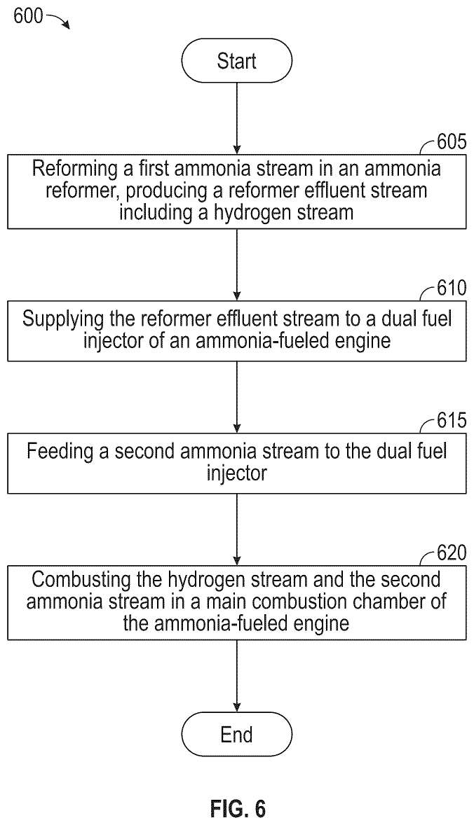

Referring now to FIG. 6, FIG. 6 is a flow diagram of a method 600 in accordance with one or more embodiments. In step 605, a first ammonia stream 405 is reformed in an ammonia reformer 401, producing a reformer effluent stream including a hydrogen stream 409.

In step 610, the reformer effluent stream is separated into a retentate stream and a pure hydrogen stream in a selective membrane 403, with the pure hydrogen stream supplied to a dual fuel injector 106 of an ammonia-fueled engine 101.

In step 615, a second ammonia stream 407 is fed to the dual fuel injector 106. In step 620, the hydrogen stream 409 and the second ammonia stream 407 are combusted in a main combustion chamber 116 of the ammonia-fueled engine 101.

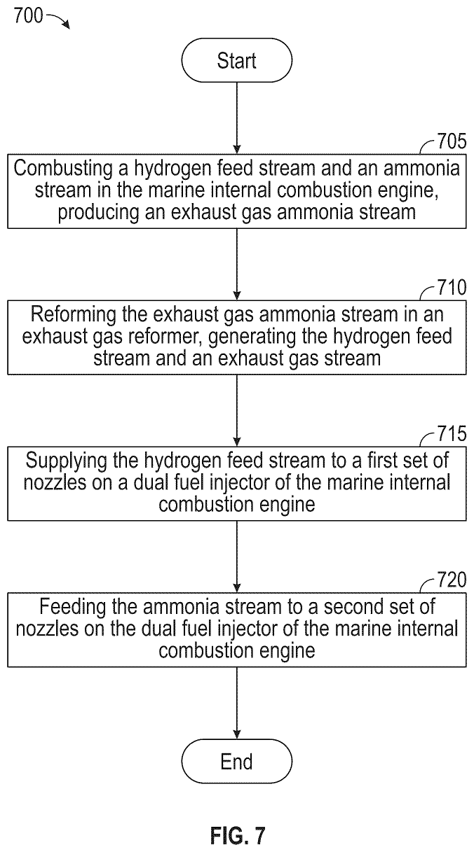

FIG. 7 is a flow diagram of a method 700 in accordance with one or more embodiments. In step 705, a hydrogen feed stream 503 and an ammonia stream are combusted in the marine internal combustion engine 101, producing an exhaust gas ammonia stream.

In step 710, the exhaust gas ammonia stream is reformed in an exhaust gas reformer 501, generating the hydrogen feed stream 503 and an exhaust gas stream.

In step 715, the hydrogen feed stream 503 is supplied to a first set of nozzles on a dual fuel injector 106 of the marine internal combustion engine 101 as the hydrogen feed stream 503. In step 720, the ammonia stream is fed to a second set of nozzles on the dual fuel injector 106 of the marine internal combustion engine 101 as the ammonia stream.

Embodiments of the present disclosure may provide at least one of the following advantages. The use of ammonia in marine engines significantly reduces Green House Gas (GHG) emissions. The use of hydrogen in ammonia fueled marine engines improves engine performance and reduces emissions during combustion. This ensures ammonia combustion improvements and ammonia slip reduction by increasing the flame propagation.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A system for combustion comprising:
a dual fuel injector disposed centrally on a cylinder head and in fluid communication with a main combustion chamber of a marine engine, wherein the dual fuel injector has a first set of one or more nozzles for injecting an ammonia stream and a second set of one or more nozzles for injecting a hydrogen stream;
a spark plug disposed adjacent to the dual fuel injector and in the fluid communication with the main combustion chamber;
an ammonia tank fluidly connected to a first set of one or more orifices of the dual fuel injector; and
a hydrogen tank fluidly connected to a second set of one or more orifices of the dual fuel injector.

2. The system of claim 1, further comprising:
wherein an ammonia spray jet is larger compared to a hydrogen spray jet, and
wherein an angle between the ammonia spray jet and the hydrogen spray jet is from 0° to 20°.

3. The system of claim 1, further comprising:
wherein a first set of nozzles for injecting the ammonia stream comprises between 8 to 10 nozzles.

4. The system of claim 1, further comprising:
wherein a second set of nozzles for injecting the hydrogen stream comprises between 10 to 12 nozzles.

5. The system of claim 3, further comprising:
wherein the first set of one or more nozzles for injecting the ammonia stream have a diameter between 300 and 500 microns.

6. The system of claim 4, further comprising:
wherein the second set of one or more nozzles for injecting the hydrogen stream has a diameter between 50 and 100 microns.

7. A process of reforming ammonia into hydrogen and combusting ammonia and hydrogen, the process comprising:
reforming a first ammonia stream in an ammonia reformer, producing a reformer effluent stream including a hydrogen stream;
supplying the reformer effluent stream to a dual fuel injector of an ammonia-fueled engine;
feeding a second ammonia stream to the dual fuel injector; and
combusting the hydrogen stream and the second ammonia stream in a main combustion chamber of the ammonia-fueled engine.

8. The process of claim 7, further comprising separating the reformer effluent stream into a retentate stream and a pure hydrogen stream using a selective membrane and supplying the pure hydrogen stream into the dual fuel injector as the reformer effluent stream.

9. The process of claim 8, further comprising utilizing an external pump at an exit of the selective membrane to pressurize generated hydrogen stream to an injection pressure from 100 bar to 300 bar before supplying the generated hydrogen stream to the dual fuel injector.

10. The process of claim 8, further comprising monitoring pressure drop across the selective membrane.

11. A process for operating a marine internal combustion engine, comprising:
combusting a hydrogen feed stream and an ammonia stream in the marine internal combustion engine, producing an exhaust gas ammonia stream;
reforming the exhaust gas ammonia stream in an exhaust gas reformer, generating the hydrogen feed stream and an exhaust gas stream;
supplying the hydrogen feed stream to a first set of nozzles on a dual fuel injector of the marine internal combustion engine; and
feeding the ammonia stream to a second set of nozzles on the dual fuel injector of the marine internal combustion engine.

12. The process of claim 11, where the reforming comprises converting unburnt ammonia in the exhaust gas ammonia stream into a raw hydrogen stream using the exhaust gas reformer.

13. The process of claim 11, further comprising separating the raw hydrogen stream into the hydrogen feed stream and a retentate stream including N₂and H₂ using a hydrogen selective membrane fluidly connected between the exhaust gas reformer and the dual fuel injector.

14. The process of claim 11, further comprising utilizing an external heater in a catalytic surface to raise a temperature from 300 °C to 350 °C to allow chemical reaction occur more efficiently.

15. The process of claim 11, further comprising utilizing a vacuum pump located at an outlet of the exhaust gas reformer to suck air from an engine so as to remove any air and gas build up in the engine, wherein conversion efficiency is improved by creating different pressure across hydrogen selective membranes.
